(19) United States
(12) Patent Application Publication
(10) Pub. No.: US 2005/0074646 A1
(43) Pub. Date: Apr. 7, 2005

(54) Apparatus and method for solid oxide fuel cell and thermo photovoltaic converter based power generation system

(76) Inventors: Kaushik Rajashekara, Carmel, IN (US); Gerald Thomas Fattic, Fishers, IN (US)

Correspondence Address: DELPHI TECHNOLOGIES, INC., M/C 480-410-202, PO BOX 5052, TROY, MI, 48007, US

(21) Appl. No.: 10/676,913

(22) Filed: Oct. 1, 2003

(51) Int. Cl. H01M 8/04; H01M 8/12; H01M 16/00

(52) U.S. Cl. 429/26; 429/30; 429/9; 429/24; 136/253

(57) ABSTRACT

A method and apparatus for providing a source of power, comprising: a solid oxide fuel cell system and a thermo photovoltaic device. The solid oxide fuel cell system provides a first source of power, wherein the solid oxide fuel cell system produces heat waste when the solid oxide fuel cell is providing the first source of power. The thermo photovoltaic device provides a second source of power and the thermo photovoltaic device provides the second source of power from the heat waste of the solid oxide fuel cell system which is further heated by a combustor in order to provide the second source of power.

### CROSS REFERENCE TO RELATED APPLICATIONS

This application is related to commonly owned and assigned U.S. patent application Ser. No. ______, entitled: APPARATUS AND METHOD FOR SOLID OXIDE FUEL CELL AND THERMIONIC EMISSION BASED POWER GENERATION SYSTEM, attorney docket no. DP-310112, filed contemporaneously with this application, the contents of which are incorporated herein by reference thereto.

### TECHNICAL FIELD

This application relates to a method and apparatus for providing a solid oxide fuel cell and thermo photovoltaic (TPV) conversion based power generation system. More particularly, a solid oxide fuel cell and thermo photovoltaic (TPV) based power generation system is provided wherein the solid oxide fuel cell provides a heat source to the thermo photovoltaic conversion device.

### BACKGROUND

Alternative fuels for vehicles and other stationary power supplies have been represented as enablers to reduce toxic emissions in comparison to those generated by conventional fuels. At the same time, tighter emission standards and significant innovation in catalyst formulations and engine controls has led to dramatic improvements in the low emission performance and robustness of gasoline and diesel engine systems. This has certainly reduced the environmental differential between optimized conventional and alternative fuel systems. However, many technical challenges remain to make the conventionally-fueled internal combustion engine a nearly zero emission system having the efficiency necessary to make the power system commercially viable.

An approach to addressing the issue of unwanted or undesirable emissions in energy or power generation systems is the employment of fuel cells, particularly solid oxide fuel cells (“SOFC”). A fuel cell is an energy conversion device that generates electricity and heat by electrochemically combining a gaseous fuel, such as hydrogen, carbon monoxide, or a hydrocarbon, and an oxidant, such as air or oxygen, across an ion-conducting electrolyte. The fuel cell converts chemical energy into electrical energy. SOFCs are constructed entirely of solid-state materials, utilizing an ion conductive oxide ceramic as the electrolyte. A conventional electrochemical cell in a SOFC is comprised of an anode, a cathode with a ceramic electrolyte.

In a typical SOFC, a fuel flows to the anode where it is oxidized by oxygen ions from the electrolyte, producing electrons that are released to the external circuit, and mostly water and carbon dioxide are removed in the fuel flow stream. At the cathode, the oxidant accepts electrons from the external circuit to form oxygen ions. The oxygen ions migrate across the electrolyte to the anode. The flow of electrons through the external circuit provides for consumable or storable electricity.

It is also noted that single-sided SOFC's have recently been demonstrated where the anode and cathode are interleaved on the same side of the electrolyte and fuel/air is flowed over them. In these SOFCs the oxidant passes over the oxygen electrode (cathode) while the fuel passes over the fuel electrode (anode), generating electricity, water, and heat.

Solid oxide fuel cells are used for generation of electrical power using hydrogen and carbon monoxide as fuels. The hydrogen is obtained from fuels including but not limited to: natural gas, gasoline, jet fuel, diesel fuel, and fuel obtained using coal gasification. The solid oxide fuel cell operates at extremely high temperatures of the order of 700-1000 degrees Celsius thus, the waste heat generated is of high temperature or high grade waste heat.

However, the SOFC usually requires a start up time of approximately 20-30 minutes and depending on the application and/or the type of SOFC the start up time may be on the order of multiple hours, which depending on the particular application of the power supply may require the use of an additional power supply or energy storage device to provide the required power during the start up time of the SOFC.

Accordingly, it is desirable to provide a power system employing a fuel cell and an alternative means for providing power during the fuel cell's start up time. In addition, it is also desirable to provide a system which utilizes the waste heat and fuel generated by the fuel cell.

### SUMMARY OF THE INVENTION

The above discussed and other drawbacks and deficiencies are overcome or alleviated by a method and apparatus for providing a source of power, comprising: a solid oxide fuel cell system and a thermo photovoltaic device. The solid oxide fuel cell system provides a first source of power, wherein the solid oxide fuel cell system produces heat waste when the solid oxide fuel cell is providing the first source of power. The thermo photovoltaic device provides a second source of power; the thermo photovoltaic device provides the second source of power from the heat waste which is further heated by a combustor in order to provide the second source of power.

A method for generating power is also provided wherein the method comprises: generating power from a thermo photovoltaic device, the thermo photovoltaic device generating power from heat received from a combustor under a first operating condition; and generating power from a solid oxide fuel system, the solid oxide fuel system generating a heat exhaust when the solid oxide fuel system generates power, the heat exhaust being routed to the thermo photovoltaic device, wherein the thermo photovoltaic device generates power from heat exhaust when the heat exhaust reaches a predetermined temperature for energy conversion by the thermo photovoltaic device.

A power supply, comprising: a solid oxide fuel cell system for providing a first source of power, the solid oxide fuel cell system producing heat waste when the solid oxide fuel cell is providing the first source of power; and a thermo photovoltaic device for providing a second source of power, the thermo photovoltaic device providing the second source of power from the heat waste which is provided to a combustor for further heating.

The above-described and other features and advantages of the present invention will be appreciated and understood by those skilled in the art from the following detailed description, drawings, and appended claims.

### BRIEF DESCRIPTION OF THE DRAWINGS

FIG. 1 is a schematic illustration of a fuel cell and thermo photovoltaic converter emission based power system in accordance with an exemplary embodiment of the present invention;

FIG. 2 is a schematic illustration of thermo photovoltaic conversion process;

FIG. 3 is a graph which shows efficiency and power density limitations at various temperatures for different materials considered for use in TPV devices;

FIG. 4 is a graph which shows the maximum output power for an ideal TPV system with GaSb (Eg=0.68 eV) under different temperatures; and

FIG. 5 is a graph illustrating the combined efficiency of a fuel cell and thermo photovoltaic converter emission based power system presuming a 65% utilization of the waste heat of the fuel cell and a 15% conversion efficiency of the thermo photovoltaic device.

### DETAILED DESCRIPTION OF EXEMPLARY EMBODIMENTS

Disclosed herein is an apparatus and system that combines two power systems wherein the waste by product of one system is used to generate power in the other system. Also, the other system provides power upon demand while one system has a time delay in order to reach a power output configuration when the same is activated from a non-power generation configuration.

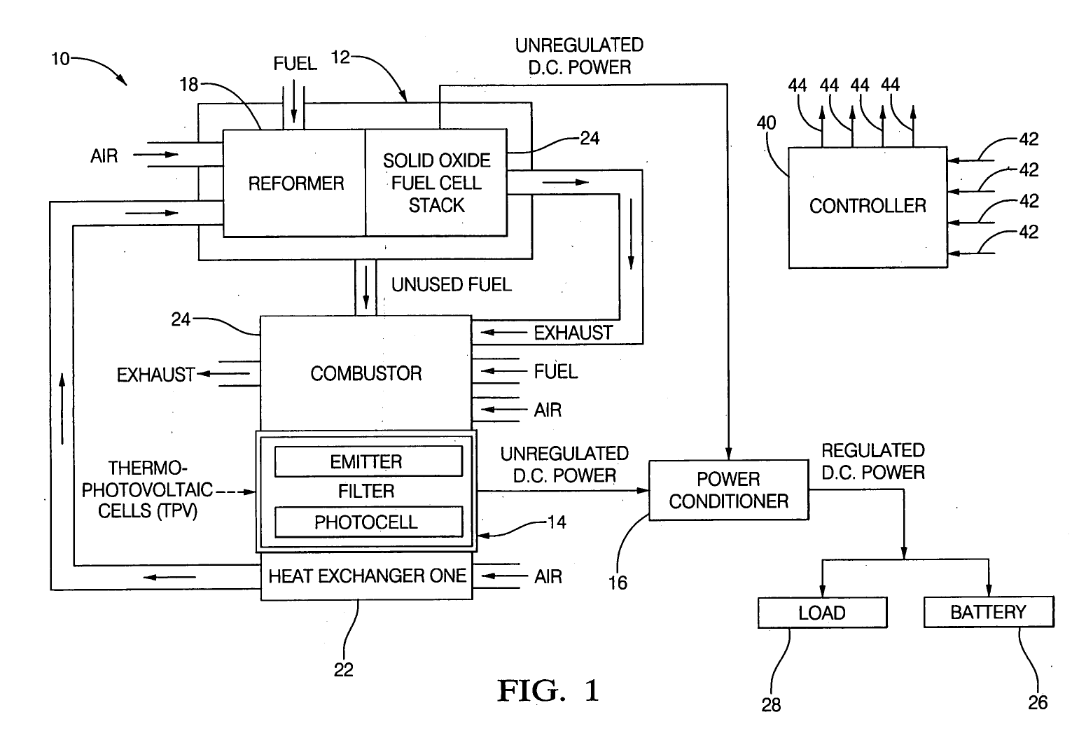

Referring now to FIG. 1, a fuel cell and thermo photovoltaic converter emission based power system 10 is illustrated. Fuel cell and thermo photovoltaic converter emission system 10 comprises a fuel cell 12 and a thermo photovoltaic converter device 14 each being configured to provide DC power to a power conditioner 16, which converts the unregulated DC power of the fuel cell and the thermo photovoltaic converter emission device to regulated DC power or alternatively AC power.

In an exemplary embodiment, fuel cell 12 comprises a reformer 18 and a solid oxide fuel stack 20. It is understood the reformer may be a separate device or if the fuel supplied to the fuel cell stack is suitable no reformer is necessary.

Different types of SOFC systems exist, including tubular or planar systems. These various systems can operate with different cell configurations therefore, reference to a particular cell configuration and components for use within a particular cell configuration are intended to be provided as examples and the present invention is not intended to be limited by the same.

Generally, the system may comprise at least one SOFC, one or more heat exchangers 22, a combustor 24, and power conditioner 16 for providing power to either or both an electric storage medium 26 or a multiplicity of electrical loads 28. If the loads and the power sources are compatible, the power conditioner may not be required. Thus, the power conditioner is optional.

During operation the SOFC can be operated at high adiabatic temperatures, e.g. up to about 1,000° C., with typical operating temperatures of about 600° C. to about 900° C., and preferably about 650° C. to about 800° C. of course these temperatures may vary. Typically at least one heat exchanger is employed to cool the SOFC effluent. However, and in accordance with exemplary embodiments of the present invention the heated exhaust is provided as a source of heat to the thermo photovoltaic energy conversion device. More particularly, the heated exhaust and unused fuel is provided to combustor 24, which in accordance with an exemplary embodiment and as will be discussed herein provides the necessary heat to an emitter of the thermo photovoltaic device in order to produce power.

To facilitate the production of electricity by the SOFC, a direct supply of simple fuel, e.g., hydrogen, carbon monoxide, and/or methane is preferred. However, concentrated supplies of these fuels are generally expensive and difficult to supply. Therefore, the fuel utilized can be obtained by processing a more complex fuel source. The actual fuel utilized in the system is typically chosen based upon the application, expense, availability, and environmental issues relating to the fuel. Possible fuels include hydrocarbon fuels, including, but not limited to, liquid fuels, such as gasoline, diesel, ethanol, methanol, kerosene, and others; gaseous fuels, such as natural gas, propane, butane, and others; and “alternative” fuels, such as hydrogen, biofuels, dimethyl ether, and others; synthetic fuels, such as synthetic fuels produced from methane, methanol, coal gasification or natural gas conversion to liquids, and combinations comprising at least one of the foregoing methods, and the like; as well as combinations comprising at least one of the foregoing fuels.

Furthermore, the fuel for the SOFC can be processed in reformer 18. A reformer generally converts one type of fuel to a fuel usable by the SOFC (e.g., hydrogen).

Other examples of SOFC and potential applications are found in U.S. Pat. Nos. 6,230,494 and 6,321,145, the contents of which are incorporated herein by reference thereto.

The SOFC may be in one embodiment be used in conjunction with an engine, for example, to produce power to a vehicle. Within the engine, SOFC effluent, air, and/or fuel are burned to produce energy, while the remainder of unburned fuel and reformed fuel is used as fuel in the combustor for providing heat to the thermo photovoltaic converter.

As discussed, herein the term “engine” is meant in the broad sense to include all combustors which combust hydrocarbon fuels internal combustion engines.

As illustrated in FIG. 1 the heated exhaust of the fuel cell is provided to thermo photovoltaic device 14 via combustor 24 which brings the heated exhaust to the required temperature for energy conversion by the thermo photovoltaic device. In addition, the unused fuel of fuel cell 12 is also provided to the combustor for use in the heating process. Accordingly, two byproducts of the fuel cell are used by combustor 24 (e.g., heated exhaust and unused fuel).

Although illustrated as being separated from the fuel cell 12, it is understood that combustor 24 is capable of being positioned to be directly coupled to fuel cell 12 in order to receive the heated exhaust and/or unused fuel produced by the fuel cell.

In accordance with an exemplary embodiment the thermo photovoltaic converter energy conversion device is a device that can convert the heat energy or exhaust of the SOFC (after heating by the combustor) into electric energy by thermo photovoltaic energy conversion.

As is known in the related arts thermo photovoltaic energy conversion involves a process wherein electrons are emitted from a surface by introducing heat sufficient to cause some electrons of the surface to overcome retarding forces at the surface in order to escape.

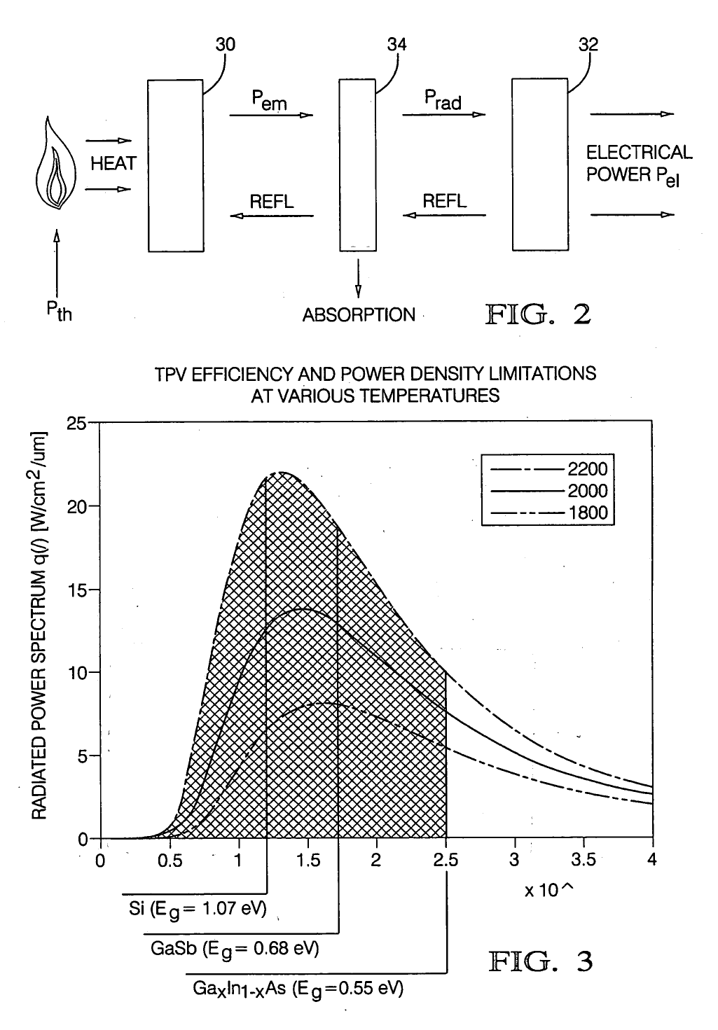

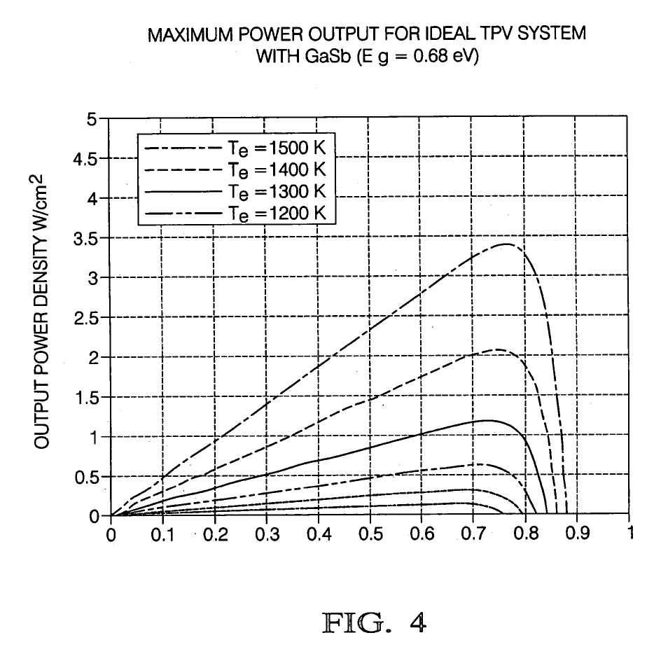

Referring now to FIG. 2, thermo photovoltaic TPV device 14 comprises at least one emitter 30, at least one photocell 32 and a filter 34 disposed therebetween. During TPV conversion, the combustion heated emitter produces electromagnetic radiation. The emitter 30 consists of a surface coated with materials whose radiation emissivity is maximum in a narrow spectral range. Selective emitters such as the rare earth oxides ytterbia and erbia are heated to re-emit in a narrow band spectrum. A selective filter 34 transmits that part of the radiation with photon energies above the bandgap of the photocells and reflects the lower energy radiation back to the emitter for recuperation. Based on the incident radiation, power is produced by the photovoltaic cells 32, such as Gallium Antimony (GaSb) which is mounted in close proximity to the source of radiation. The output electrical power of the photocell can be used to charge the battery of an automobile or for as a power source for various applications.

It is understood and contemplated that an exemplary embodiment of the present invention will employ a thermo photovoltaic device which is capable of providing power from the waste heat of the SOFC after it is heated by combustor 24 to a temperature high enough to produce thermo photovoltaic energy conversion.

In accordance with an exemplary embodiment, system 10 is contemplated for use with a thermo photovoltaic device which can produce power when the heat exhaust of the fuel cell is provided to a combustor which heats the exhaust to a temperature sufficient to cause TPV device 14 to produce an electrical output.

An exemplary temperature of the heated exhaust of the fuel cell is up to 1,000° C. with an optimum operating temperature of about 700° C. Thus, the combustor must heat the exhaust up to the required temperature from this elevated temperature for energy conversion by TPV device 14.

The principle of Thermo-photovoltaic (TPV) power production is the conversion of heat into electricity. The basic TPV conversion process is shown in FIG. 2. Fossil fuels such as natural gas are burned to generate thermal radiation spectrum. The heat source should have a temperature of no less than 1000 K to achieve reasonable conversion efficiency. The combustion heated emitter produces electromagnetic radiation. The emitter consists of a surface coated with materials whose radiation emissivity is maximum in a narrow spectral range. Selective emitters such as the rare earth oxides ytterbia and erbia are heated to re-emit in a narrow band spectrum. A selective filter transmits that part of the radiation with photon energies above the bandgap of the photocells and reflects the lower energy radiation back to the emitter for recuperation. Based on the incident radiation, power is produced by the photovoltaic cells. Currently, the only material which is being used commercially for TPV applications is GaSb with diffused p-doping on an n-type substrate. The output electrical power of the photocell can be used to charge the battery of a vehicle.

The TPV is similar to solar photovoltaic cells except that the source for TPV applications is much closer and has a temperature of around 1500-2000 K rather than 5800 K for the sun. The infra-red radiation is of larger interest in TPV applications instead of the visible part of the spectrum for solar cells. Hence lower band-gap photovoltaic cells which have band gaps just below the narrow emission band have to be chosen for maximum efficiency of electrical power generation.

The efficiency of a thermo-photovoltaic cell is similar to existing solar cells. Since the source for TPV is much closer than the sun, the total power incident on a TPV cell can actually be greater than that for a solar cell. Very high power densities of up to 100 kW/m2, equivalent to more than 100 times that of a solar concentration can be achieved. The TPV consists of many components, such as combustor, emitter, PV cell, optical elements and cooling. To achieve overall efficiencies of 20-25%, good thermal recuperation is needed.

A TPV power generation unit is extremely clean and quiet. Unburned HC and CO emissions are low enough to be qualified as a virtual zero emission power source for vehicular applications.

As illustrated in FIG. 1, combustor 24 is provided with fuel and air to provide heat to thermo photovoltaic device 14 in order to induce a power output in accordance with the methodologies discussed above. Combustor 24 may be any combustion device capable of providing at least a heat output. For example, and in an alternative embodiment start up combustor may be an engine of a vehicle such as a hybrid vehicle. Combustor 24 is configured to provide the required heat to the thermo photovoltaic device until fuel cell stack 20 has reached an operating temperature wherein the heated exhaust of the fuel cell stack is then heated to provide the required heat to the thermo photovoltaic device.

During this phase of operation the combustor will not have to provide as much heat as the exhaust from the SOFC will be preheated. In addition, the unused fuel of the SOFC is supplied to the combustor providing further efficient operation of the combined power system. Thus, an efficient use of the waste and fuel and waste heat of the SOFC is provided. Accordingly, and in accordance with exemplary embodiments of the present invention an efficient dual power generating system is provided.

On the other hand, and when the SOFC is inactive and there is a power demand, the combustor will, through the use of thermo photovoltaic device 14 provide electrical power in applications where the 20-30 minute warm up period of the fuel cell stack is undesirable. Thus, thermo photovoltaic device 14 provides power immediately upon request through the use combustor 24. The use of combustor 24 will eliminate the need for an electric storage medium which is typically used to provide a source of power in systems employing fuel cell systems, which can take up to 30 minutes to start-up (e.g., produce power and heat).

Heat exchanger 22 is configured and positioned to provide cooling air to the photocell of the thermo photovoltaic device. The output of this heat exchanger is in fluid communication with the fuel cell stack wherein the heated air from exchanger 22, after cooling the photocell, is provided to fuel cell stack 10 in order to assist in bringing the stack up to an operating temperature as well as reducing the amount of energy required to heat the air entering into the SOFC. This will assist in reducing the warm up time for the SOFC when the fuel cell was inactive and the power demand was met by device 14 through combustor 24 and the SOFC was subsequently activated. Accordingly, and in order to provide additional efficiency, the heat exhaust from the heat exchanger can be recirculated back into fuel cell system 12.

Examples of Thermophotovoltaic devices are found in U.S. Pat. Nos. 5,312,521; 5,593,509; and 5,942,047 the contents of which are incorporated herein by reference thereto. Of course, any thermo photovoltaic device capable of providing an electrical output from the heated exhaust of the fuel cell stack is contemplated to be used with exemplary embodiments of the present invention.

A circuit provides the generated power to power conditioner 16. In an exemplary embodiment power conditioner regulates the DC power provided by the fuel cell and the thermo photovoltaic device. In addition, and as an alternative, power conditioner is a DC/AC inverter.

In any of the embodiments discussed herein a controller or control module 40 is provided to operate the various components of the systems of exemplary embodiments of the present invention. The controller comprises among other elements a microprocessor for receiving signals 42 indicative of the system performance as well as providing signals 44 for control of various system components. The controller will also comprise read only memory and programmable memory in the form of an electronic storage medium for executable programs or algorithms and calibration values or constants, random access memory and data buses for allowing the necessary communications (e.g., input, output and within the controller) with the controller in accordance with known technologies.

The controller receives various signals from various sensors in order to determine various operating schemes of the disclosed system for example, whether the fuel cell system is warmed up and operating at a predetermined state wherein the desired heat exhaust is obtainable for the thermo photovoltaic device.

In accordance with operating programs, algorithms, look up tables and constants resident upon the microcomputer of the controller various output signals are provided by the controller. These signals can be used to vary the operation of the fuel cell stack, the thermo photovoltaic device and alternatively the start up combustor. The controller will also receive signals related to requests for power demands.

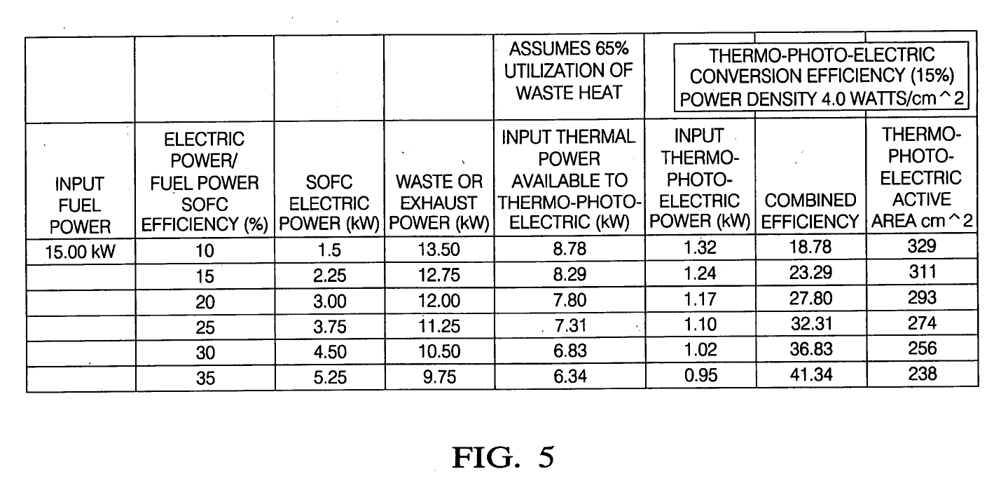

Referring now to FIG. 5, an example of the combined efficiency of a power supply, comprising: a solid oxide fuel cell system and a thermo photovoltaic device is provided wherein various SOFC efficiencies are used to illustrate the combined efficiency of the system. The examples of FIG. 5 are based upon a 65% utilization of the waste heat of the SOFC with a thermo-electric conversion efficiency of 15% by the thermo photovoltaic device. In addition, FIG. 5 also illustrates the required thermoelectric active area (cm²) based upon an efficiency of 4.0 watts/cm².

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. It should also be noted that the terms “first”, “second”, and “third” and the like may be used herein to modify elements performing similar and/or analogous functions. These modifiers do not imply a spatial, sequential, or hierarchical order to the modified elements unless specifically stated.

1. A power supply, comprising:
a solid oxide fuel cell system for providing a first source of power, said solid oxide fuel cell system producing heat waste; and
a thermo photovoltaic device for providing a second source of power, said thermo photovoltaic device providing said second source of power from said heat waste which is provided to a combustor for further heating.

2. The power supply as in claim 1, wherein said heat waste is heated air and an exhaust conduit provides fluid communication of said heat waste between an exhaust of said fuel cell system and an inlet of said combustor.

3. The power supply as in claim 2, wherein unused fuel of said fuel cell system is provided to said combustor for use in heating said heat waste.

4. The power supply as in claim 1, wherein unused fuel of said fuel cell system is provided to said combustor for use in heating said heat waste.

5. The power supply as in claim 1, wherein a heat exchanger is configured to cool at least one photocell of said thermo photovoltaic device, wherein an exhaust of said heat exchanger is provided to said fuel cell system.

6. The power supply as in claim 5, wherein said power supply is configured for use in a vehicle or in any power generation system.

7. The power supply as in claim 6, further comprising a power conditioner for receiving and conditioning power generated by said fuel cell system and said thermo photovoltaic device.

8. The power supply as in claim 1, wherein said fuel cell system comprises a plurality of fuel cell stacks providing heat waste to a plurality of thermo photovoltaic devices.

9. The power supply as in claim 1, wherein a heat exchanger of said plurality of thermo photovoltaic devices provides an exhaust to an inlet conduit of said fuel cell system.

10. The power supply as in claim 3, where said heat waste of said solid oxide fuel cell system is within a range defined by a lower limit of 400 degrees Celsius and an upper limit of 1,200 degrees Celsius when said solid oxide fuel cell system is providing said first source of power.

11. The power supply as in claim 1, further comprising a heat exchanger, said heat exchanger providing an inlet and an exhaust of air to at least one photocell of said thermo photovoltaic device, wherein unheated air is supplied to said inlet and air heated by said photocell is supplied to said exhaust, wherein said photocell is maintained at a temperature differential between an emitter of said thermo photovoltaic device.

12. The power supply as in claim 1, wherein said thermo photovoltaic device and said combustor provide an initial source of power during a warm up phase of said fuel cell system, said warm up phase being the time necessary to bring said fuel cell system from a non-power producing configuration to a power producing configuration.

13. The power supply as in claim 12, further comprising a heat exchanger, said heat exchanger providing an inlet and an exhaust of air to at least one photocell of said thermo photovoltaic device, wherein unheated air is supplied to said inlet and air heated by said photocell is supplied to said exhaust, wherein said photocell is maintained at a temperature differential between an emitter of said thermo photovoltaic device; and
a controller employing a control algorithm for controlling the operation of said fuel cell system, said combustor, and said thermo photovoltaic device in response to signals received from said fuel cell system, said combustor, and said thermo photovoltaic device, said signals at least corresponding to the operational temperature of said fuel cell system, said combustor, said thermo photovoltaic device and heat exhaust thereof.

14. The power supply as in claim 1, wherein said heat waste is generated before, during and after said fuel cell system is generating said first source of power.

15. A method for generating power, comprising:
generating power from a thermo photovoltaic device, said thermo photovoltaic device generating power from heat received from a combustor under a first operating condition; and
generating power from a solid oxide fuel system, said solid oxide fuel system generating a heat exhaust, said heat exhaust being routed to said combustor, wherein said thermo photovoltaic device generates power from the heat exhaust from said combustor when said heat exhaust is heated by said combustor to a predetermined temperature for energy conversion by said thermo photovoltaic device.

16. The method as in claim 15, wherein said heat exhaust is provided to said combustor via an exhaust conduit, said exhaust conduit providing fluid communication of said heat exhaust between an exhaust of said solid oxide fuel cell system and an inlet of said combustor.

17. The method as in claim 15, wherein unused fuel of said solid oxide fuel cell system is provided to said combustor for use in heating said heat exhaust to said predetermined temperature.

18. The method as in claim 17, further comprising:
cooling at least one photocell of said thermo photovoltaic device by a heat exchanger, wherein an exhaust of said heat exchanger is provided to said fuel cell system.

19. The method as in claim 15, wherein said heat exhaust of said solid oxide fuel cell system is within a range defined by a lower limit of 400 degrees Celsius and an upper limit of 1,200 degrees Celsius when said solid oxide fuel cell system is providing said first source of power.

20. The method as in claim 15, wherein said heat exhaust is generated before, during and after said solid oxide fuel cell system is generating said first source of power.
